(19) United States
(12) Patent Application Publication
(10) Pub. No.: US 2023/0064257 A1
(43) Pub. Date: Mar. 2, 2023

(54) IMAGE FORMING APPARATUS

(71) Applicant: FUJIFILM Business Innovation Corp., Kanagawa (JP)

(72) Inventors: Yoko MIYAMOTO, Kanagawa (JP); Tomoaki YOSHIOKA, Kanagawa (JP); Kazuyoshi HAGIWARA, Kanagawa (JP); Toshiaki BABA, Kanagawa (JP)

(73) Assignee: FUJIFILM Business Innovation Corp., Kanagawa (JP)

(21) Appl. No.: 17/577,458

(22) Filed: Jan. 18, 2022

(30) Foreign Application Priority Data
Aug. 25, 2021 (JP) 2021-136802

(51) Int. Cl. G03G 15/16

(52) U.S. Cl. CPC G03G 15/1605

(57) ABSTRACT

An image forming apparatus includes at least one upper image forming unit in which an image holding unit is disposed above a transfer unit in such a manner as to face the transfer unit with a transfer medium, which moves in a predetermined direction, interposed between the image holding unit and the transfer unit and at least one lower image forming unit in which an image holding unit is disposed below a transfer unit in such a manner as to face the transfer unit with the transfer medium interposed between the image holding unit and the transfer unit, the transfer unit of the upper image forming unit and the transfer unit of the lower image forming unit each including a transfer member that extends in a width direction crossing the direction of movement of the transfer medium and that is brought into contact with the transfer medium and a pressing unit that presses the transfer member toward the image holding unit, and the pressing units being set in such a manner that a pressing force that is applied by one of the pressing units to the transfer member of the upper image forming unit is larger than a pressing force that is applied by another one of the pressing units to the transfer member of the lower image forming unit in a direction that makes pressing loads of the transfer members against the image holding units equal.

### CROSS-REFERENCE TO RELATED APPLICATIONS

This application is based on and claims priority under 35 USC 119 from Japanese Patent Application No. 2021-136802 filed Aug. 25, 2021.

### BACKGROUND

### (i) Technical Field

The present disclosure relates to an image forming apparatus.

### (ii) Related Art

As examples of this type of image forming apparatus, there are known image forming apparatuses described in Japanese Unexamined Patent Application Publication No. 2002-108045 (Description of the Embodiments, FIG. 1), Japanese Unexamined Patent Application Publication No. 5-84972 (Embodiment, FIG. 8), Japanese Unexamined Patent Application Publication No. 2009-80325 (Best Mode for Carrying out the Invention, FIG. 1), and Japanese Unexamined Patent Application Publication No. 2001-246779 (Description of the Embodiments, FIG. 2).

Japanese Unexamined Patent Application Publication No. 2002-108045 discloses an image forming apparatus including an intermediate transfer belt that is horizontally stretched by tension rollers, chromatic-image forming stations each of which includes a photoconductor drum disposed so as to face an upper flat surface portion of the intermediate transfer belt, and a black-image forming station that includes a photoconductor drum disposed so as to face a lower flat surface portion of the intermediate transfer belt.

Japanese Unexamined Patent Application Publication No. 5-84972 discloses an image forming apparatus that forms images of four colors. In this image forming apparatus, an intermediate transfer belt is disposed so as to be stretched in a substantially isosceles triangular shape having an upper inclined surface and a lower inclined surface. Two image forming units are arranged on the upper inclined surface of the intermediate transfer belt, and other two image forming units are arranged on the lower inclined surface of the intermediate transfer belt.

Japanese Unexamined Patent Application Publication No. 2009-80325 discloses an image forming apparatus in which a plurality of image forming units are arranged in two or more transfer regions, which are formed by partitioning a transfer belt member by using a plurality of stretching members, in such a manner that visible images formed by the image forming units are transferred onto the transfer belt member and then transferred onto a recording medium.

Japanese Unexamined Patent Application Publication No. 2001-246779 discloses an image forming apparatus in which a yellow image forming unit and a cyan image forming unit that are included in a first image forming section are arranged on an upper surface side of an intermediate transfer belt and in which a magenta image forming unit and a black image forming unit that are included in a second image forming section are arranged on a lower surface side of the intermediate transfer belt. In this image forming apparatus, a single LED is disposed for the two image forming units of the first image forming section such that image light that is radiated from the LED is switched in response to two rotational operations of the intermediate transfer belt and radiated onto a photoconductor drum of each of the two image forming units, and another single LED is disposed for the two image forming units of the second image forming section such that image light that is radiated from the LED is switched in response to two rotational operations of the intermediate transfer belt and radiated onto a photoconductor drum of each of the two image forming units.

### SUMMARY

Aspects of non-limiting embodiments of the present disclosure relate to providing an image forming apparatus that includes an upper image forming unit including an image holding unit disposed above a transfer unit in such a manner as to face the transfer unit with a transfer medium interposed therebetween and a lower image forming unit including an image holding unit disposed below a transfer unit in such a manner as to face the transfer unit with the transfer medium interposed therebetween and that is capable of suppressing variations in transfer loads of the transfer units of the upper and lower image forming units.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including at least one upper image forming unit in which an image holding unit is disposed above a transfer unit in such a manner as to face the transfer unit with a transfer medium, which moves in a predetermined direction, interposed between the image holding unit and the transfer unit and at least one lower image forming unit in which an image holding unit is disposed below a transfer unit in such a manner as to face the transfer unit with the transfer medium interposed between the image holding unit and the transfer unit, wherein the transfer unit of the upper image forming unit and the transfer unit of the lower image forming unit each include a transfer member that extends in a width direction crossing the direction of movement of the transfer medium and that is brought into contact with the transfer medium and a pressing unit that presses the transfer member toward the image holding unit, and wherein the pressing units are set in such a manner that a pressing force that is applied by one of the pressing units to the transfer member of the upper image forming unit is larger than a pressing force that is applied by another one of the pressing units to the transfer member of the lower image forming unit in a direction that makes pressing loads of the transfer members against the image holding units equal.

### BRIEF DESCRIPTION OF THE DRAWINGS

Exemplary embodiments of the present disclosure will be described in detail based on the following figures, wherein:

FIG. 1A is a diagram illustrating an overview of an exemplary embodiment of an image forming apparatus to which the present disclosure is applied, FIG. 1B is a diagram illustrating a principal portion of the configuration of an upper image forming unit, and FIG. 1C is a diagram illustrating a principal portion of the configuration of a lower image forming unit;

FIG. 2A is a diagram illustrating a configuration example of a transfer unit included in the upper image forming unit illustrated in FIG. 1B, FIG. 2B is a diagram illustrating a configuration example of a transfer unit included in the lower image forming unit illustrated in FIG. 1C, FIG. 2C is a diagram illustrating another configuration example of the transfer unit included in the upper image forming unit, and FIG. 2D is a diagram illustrating another configuration example of the transfer unit included in the lower image forming unit;

FIG. 3 is a diagram illustrating the overall configuration of the image forming apparatus according to a first exemplary embodiment;

FIG. 4 is a perspective view illustrating the details of a pressing mechanism of a transfer device used in an upper image forming engine;

FIG. 5 is a view as seen in the direction of arrow V of Fib. 4;

FIG. 6 is a diagram illustrating, like FIG. 5, the details of a pressing mechanism of a transfer device used in a lower image forming engine;

FIG. 7A is a diagram schematically illustrating a principal portion of the transfer device used in the upper image forming engine, and FIG. 7B is a diagram schematically illustrating a principal portion of the transfer device used in the lower image forming engine;

FIG. 8A is a diagram illustrating the acting state of a pressing load of a transfer roller of the transfer device by the upper image forming engine, FIG. 8B is a diagram illustrating the acting state of a pressing load of a transfer roller of the transfer device by the lower image forming engine, and FIG. 8C is a graph illustrating distribution of the pressing load of the transfer roller of the transfer device;

FIG. 9A is a diagram schematically illustrating a principal portion of a transfer device used in an upper image forming engine of an image forming apparatus according to a second exemplary embodiment, and FIG. 9B is a diagram schematically illustrating a principal portion of a transfer device used in a lower image forming engine of the image forming apparatus;

FIG. 10A is a diagram schematically illustrating a principal portion of a transfer device used in an upper image forming engine of an image forming apparatus according to a third exemplary embodiment, and FIG. 10B is a diagram schematically illustrating a principal portion of a transfer device used in a lower image forming engine of the image forming apparatus;

FIG. 11A is a diagram schematically illustrating a principal portion of a transfer device used in an upper image forming engine of an image forming apparatus according to a fourth exemplary embodiment, and FIG. 11B is a diagram schematically illustrating a principal portion of a transfer device used in a lower image forming engine of the image forming apparatus;

FIG. 12A is a diagram schematically illustrating a principal portion of a transfer device used in an upper image forming engine of an image forming apparatus according to a fifth exemplary embodiment, and FIG. 12B is a diagram schematically illustrating a principal portion of a transfer device used in a lower image forming engine of the image forming apparatus; and

FIG. 13A is a diagram illustrating a principal portion of a pressing mechanism holding a first end of a transfer device used in an upper image forming engine of an image forming apparatus according to a sixth exemplary embodiment, FIG. 13B is a diagram illustrating a principal portion of a pressing mechanism holding a second end of a transfer device used in an upper image forming engine of an image forming apparatus, and FIG. 13C is a diagram illustrating a principal portion of a pressing mechanism holding a first end of a transfer device used in a lower image forming engine of the image forming apparatus.

### DETAILED DESCRIPTION

### Overview of Exemplary Embodiments

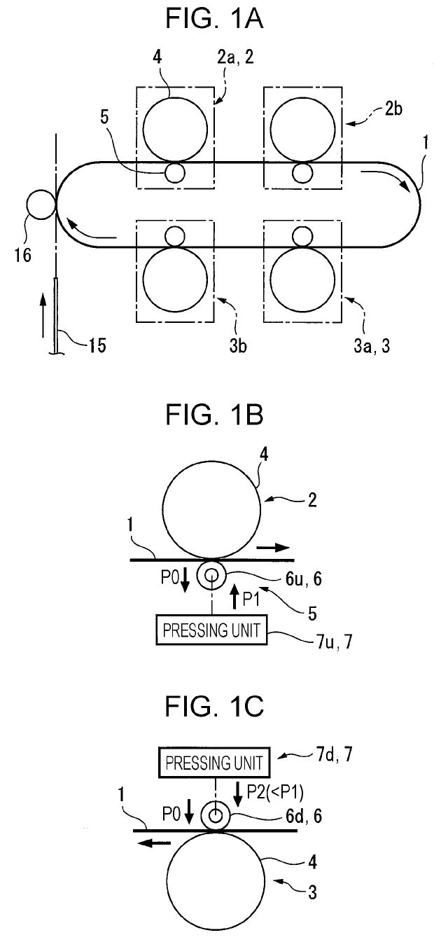

FIG. 1A is a diagram illustrating an overview of an exemplary embodiment of an image forming apparatus to which the present disclosure is applied.

In FIG. 1A, the image forming apparatus includes a transfer medium 1 (an intermediate transfer medium is used in the present exemplary embodiment) that moves along a circular path extending in a substantially horizontal direction, upper image forming units 2 (specifically, two upper image forming units 2a and 2b are arranged side by side in the present exemplary embodiment) each of which includes a transfer unit 5 and an image holding unit 4 that is disposed above the transfer unit 5 so as to face the transfer unit 5 with the transfer medium 1 interposed therebetween, and lower image forming units 3 (specifically, two lower image forming units 3a and 3b are arranged side by side in the present exemplary embodiment) each of which includes the transfer unit 5 and the image holding unit 4 that is disposed below the transfer unit 5 so as to face the transfer unit 5 with the transfer medium 1 interposed therebetween.

As illustrated in FIGS. 1B and 1C, the transfer units 5 of the upper image forming units 2 and the transfer units 5 of the lower image forming units 3 each extend in a width direction that crosses a direction in which the transfer medium 1 moves and each include a transfer member 6 that is brought into contact with the transfer medium 1 and a pressing unit 7 that presses the transfer member 6 toward the image holding unit 4. The pressing units 7 are set in such a manner that a pressing force that is applied to the transfer member 6 of each of the upper image forming units 2 by the corresponding pressing unit 7 is larger than a pressing force that is applied to the transfer member 6 of each of the lower image forming units 3 by the corresponding pressing unit 7 in a direction that makes the pressing loads of the transfer members 6 against their respective image holding units 4 equal.

Note that, in the image forming apparatus illustrated in FIG. 1A, images that are formed in the upper image forming units 2 and the lower image forming units 3 are transferred onto the transfer medium 1 (an intermediate transfer medium in the present exemplary embodiment) and then transferred onto recording medium 15 by a transfer device 16. However, the image forming apparatus is not limited to having this type of configuration.

In the present exemplary embodiment, the upper image forming units 2 are arranged on the upper side of the transfer medium 1, and the lower image forming units 3 are arranged on the lower side of the transfer medium 1. In this type of configuration, the influences of deflections of the transfer members 6, each of which is a component of the corresponding transfer unit 5 and each of which has an elongated shape, due to their own weight vary greatly in the longitudinal direction, and it is difficult to set transfer loads of the transfer members 6 to be equal to one another by using the same pressing units. In other words, an image quality defect is likely to occur due to large deflection of a center portion of each of the transfer members 6. For example, in each of the upper image forming units 2, the transfer load near the center of the transfer member 6 is less likely to be applied, and unevenness in image quality (mottle) is likely to occur. In each of the lower image forming units 3, there is likely to be an excessive load near the center of the transfer member 6 tends to be overloaded, and a phenomenon (retransfer) in which an image is retransferred is likely to occur.

Accordingly, the present exemplary embodiment is intended to improve the above-mentioned image quality defect by devising the pressing units 7 (specifically, pressing units 7u and 7d) of the transfer units 5 first.

In the present exemplary embodiment, by taking into consideration a weight P0 of each of the transfer members 6 (specifically, transfer members 6u and 6d), an adjustment may be performed in a direction that makes the pressing loads applied by the transfer members 6, which are used in the upper image forming units 2 and the lower image forming units 3, equal. More specifically, the weight P0 of the transfer member 6u (6) of each of the upper image forming units 2 acts in a direction opposite to the direction in which the transfer load acts, and the weight P0 of the transfer member 6d (6) of each of the lower image forming units 3 acts in the same direction as that in which the transfer load acts. Thus, it is necessary to set a pressing force P1 that is applied to each of the transfer members 6 (6u) by the corresponding pressing unit 7 and a pressing force P2 that is applied to each of the transfer members 6 (6d) by the corresponding pressing units 7 in such a manner that the relationship of P1>P2 is satisfied.

Here, it is obvious that the wording “an adjustment may be performed in a direction that makes the pressing loads applied by the transfer members 6 equal” refers to performing an adjustment in such a manner that the pressing loads of the transfer members 6 become equal to one another, and the wording also broadly includes situations in which an adjustment is performed so as to try to make the pressing loads applied by the transfer members 6 equal.

In such technical measures, examples of the upper image forming units 2 and the lower image forming units 3 broadly include those that include the image holding units 4 (photoconductors, dielectrics) and the transfer units 5, and the image forming method employed by each of the image forming units is not limited to an electrophotographic system and may be one of other methods such as an ion irradiation system.

In addition, the transfer medium 1 is not limited to an intermediate transfer medium and may be a recording medium such as a sheet. Note that, in the case where the transfer medium 1 is a recording medium, a system in which the recording medium is transported by a recording-medium transport unit (e.g., a transport belt) is employed. The direction of movement of the transfer medium 1 is not limited to the horizontal direction and may be a direction that is inclined with respect to the horizontal direction.

Each of the transfer units 5 may at least include the transfer member 6 and the pressing unit 7, and on the precondition that each of the transfer members 6 is brought into contact with the transfer medium 1, a configuration that enables each of the transfer units 5 to come into and out of contact with the transfer medium 1 by using a contact/separation mechanism is often employed. Here, such a contact/separation mechanism is not limited to a swing-type contact/separation mechanism and may be a linearly advancing/retreating mechanism.

In addition, although each of the transfer members 6 is typically assumed to be a roller member that is rotatable, each of the transfer members 6 may be a member (a belt member that is used by being stretched) other than a roller member. Here, although a solid roller member may be used as each of the roller members, a hollow roller member may be used from the standpoint of reducing the weight of each of the roller members and improving the flexural rigidity of each of the roller members.

Furthermore, each of the pressing units 7 is generally configured to press the two end portions of the transfer member 6 in the longitudinal direction of the transfer member 6, a pressing mechanism may be individually provided for each of the two end portions. Alternatively, a pressing mechanism may be provided for one of the two end portions, and the other end portion may be pressed via a link mechanism that operates in conjunction with the pressing mechanism.

A representative aspect or an exemplary aspect of the image forming apparatus according to the present exemplary embodiment will now be described.

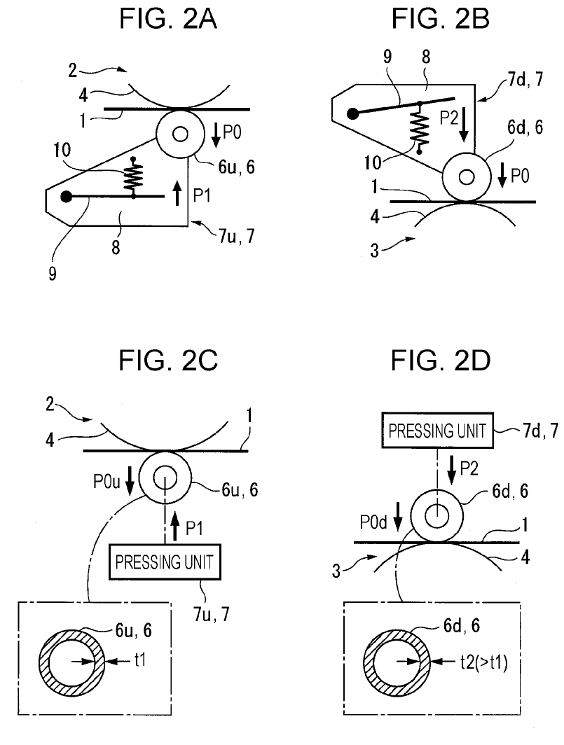

First, as a representative aspect of the pressing units 7, as illustrated in FIGS. 2A and 2B, pressing springs 10 that press the transfer members 6 (6u, 6d) are included in the pressing units 7, and the elastic restoring forces of the pressing springs 10 are adjusted. Here, although a compression spring is typically used as each of the pressing springs 10, it is obvious that a tension spring and a link arm may be used in combination with each other.

In addition, representative aspects in which the elastic restoring forces of the pressing springs 10 are adjusted includes an aspect in which a spring constant for each of the upper image forming units 2 is set to be larger than that for each of the lower image forming units 3 and an aspect in which the amount of elastic deformation (the amount of compression in the case where compression springs are used) of each of the pressing springs 10 for the upper image forming units 2 is set to be larger than that of each of the pressing springs 10 for the lower image forming units 3.

Furthermore, as a representative configuration example of each of the pressing units 7, as illustrated in FIGS. 2A and 2B, in the case where the transfer member 6 is held by a transfer holding member 8, which is swingable about a fulcrum, at a position spaced apart from the fulcrum, each of the pressing units 7 includes the transfer holding member 8, a pressing and holding member 9 that is disposed so as to be swingable about the same fulcrum with respect to the transfer holding member 8, and one of the pressing springs 10 that is held between the transfer holding member 8 and the pressing and holding member 9 so as to be capable of being elastically deformed.

In the present aspect, in order to adjust the pressing forces applied by the pressing units 7 to the transfer members 6 in the case where the pressing units 7 use the same pressing springs 10, an exemplary method that may be used is a method in which, when the distance on the pressing and holding member 9 from the fulcrum to the position where the pressing spring 10 is held is denoted by L1 (not illustrated in FIGS. 2A to 2D) and the distance on the pressing and holding member 9 from the fulcrum to the position where the transfer member 6 is held is denoted by L2 (not illustrated in FIGS. 2A to 2D), the value of L2/L1 for each of the upper image forming units 2 is set to be larger than the value of L2/L1 for each of the lower image forming units 3.

Another exemplary method that may be used is a method in which, when the distance between the position at which the pressing spring 10 is held by the transfer holding member 8 and the position at which the pressing spring 10 is held by the pressing and holding member 9 is denoted by D (not illustrated in FIGS. 2A to 2D), the value of D for each of the upper image forming units 2 is set to be larger than the value of D for each of the lower image forming units 3.

As an aspect, the pressing units 7 of the upper image forming units 2 and the pressing units 7 of the lower image forming units 3 operate independently of one another.

In the present aspect, when the two end portions of each of the transfer members 6 in the longitudinal direction of the transfer member 6 (which corresponds to the width direction of the transfer medium 1) are held by the pressing units 7, a configuration in which one of the two end portions of the transfer member 6 is held by one of the pressing units 7, and the other end portion is held by the pressing unit 7 via an interlocking mechanism may also be considered. However, from the standpoint of stably pressing the two end portions of the transfer member 6 in the longitudinal direction, the two end portions of the transfer member 6 in the longitudinal direction may be independently held by their respective pressing units 7.

In addition, from the standpoint of achieving a reduction in the manufacturing costs of the pressing units 7, all or some of the components used in at least one of the upper image forming units 2 and all or some of the components used in at least one of the lower image forming units 3 may be sharable by the pressing units 7. In the present aspect, all or some of the components used in at least one of the upper image forming units 2 or the lower image forming units 3 may be sharable by the pressing units 7 at the two end portions of the transfer members 6 in the longitudinal direction.

As the present exemplary embodiment, there is another aspect in which the above-mentioned image quality defect is improved by devising the transfer members 6 of the transfer units 5.

The image forming apparatus in this aspect includes, as illustrated in FIG. 1A and FIGS. 2C and 2D, the upper image forming units 2 (e.g., 2a and 2b) each of which includes the transfer unit 5 and the image holding unit 4 that is disposed above the transfer unit 5 so as to face the transfer unit 5 with the transfer medium 1, which moves in a predetermined direction, interposed therebetween and the lower image forming units 3 (e.g., 3a and 3b) each of which includes the transfer unit 5 and the image holding unit 4 that is disposed below the transfer unit 5 so as to face the transfer unit 5 with the transfer medium 1 interposed therebetween. The transfer units 5 of the upper image forming units 2 and the transfer units 5 of the lower image forming units 3 each extend in the width direction crossing the direction in which the transfer medium 1 moves and each include the transfer member 6 that is brought into contact with the transfer medium 1 and the pressing unit 7 that presses the transfer member 6 toward the image holding unit 4, and the transfer member 6 included in each of the upper image forming units 2 is lighter in weight than that included in each of the upper image forming units 2.

As a measure to reduce the weight of each of the transfer members 6, for example, the transfer members 6 of the upper image forming units 2 may each be formed of a hollow pipe, and the transfer members 6 of the lower image forming units 3 may each be formed of a solid roller. Alternatively, the transfer members 6 of the upper image forming units 2 and the transfer members 6 of the lower image forming units 3 may each be a transfer roller that includes a hollow pipe and an elastic rubber member disposed around the hollow pipe, and the wall thickness of each of the hollow pipes included in the upper image forming units 2 may be set to be thinner than the wall thickness of each of the hollow pipes included in the lower image forming units 3. In the latter aspect, as illustrated in FIGS. 2C and 2D, when the transfer member 6u for the upper image forming units 2 has a wall thickness t1 and the transfer member 6d for the lower image forming units 3 has a wall thickness t2, the relationship of t2>t1 may be satisfied.

In addition to the measure to reduce the weight of each of the transfer members 6, the pressing units 7 may be set in such a manner that the pressing force applied to the transfer member 6 of each of the upper image forming units 2 by the corresponding pressing unit 7 is larger than the pressing force applied to the transfer member 6 of each of the lower image forming units 3 by the corresponding pressing unit 7 in a direction that makes the pressing loads of the transfer members 6 against their respective image holding units 4 equal.

The present disclosure will be described in further detail below on the basis of the exemplary embodiments illustrated in the accompanying drawings.

### First Exemplary Embodiment

### Overall Configuration of Image Forming Apparatus

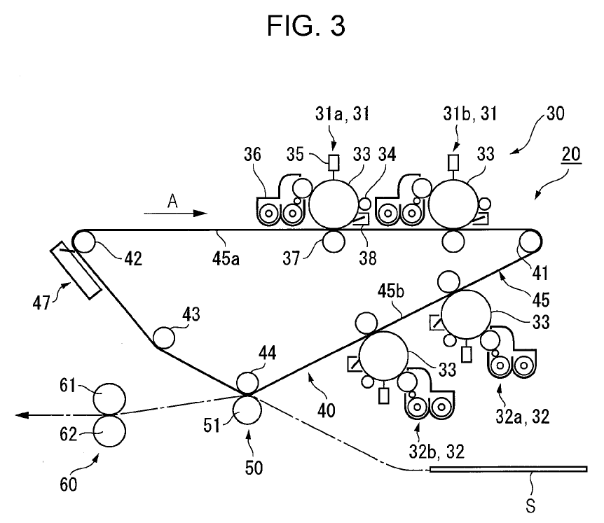

FIG. 3 illustrates the overall configuration of the image forming apparatus according to the first exemplary embodiment.

In FIG. 3, an image forming apparatus 20 includes a plurality (four in the present exemplary embodiment) of image forming engines 30 that form images of a plurality of color components (e.g., yellow, magenta, cyan, and black). In the image forming apparatus 20, an intermediate transfer module 40 is disposed such that images formed by the image forming engines 30 are temporarily transferred and held onto the intermediate transfer module 40 before they are transferred onto a recording medium S such as a sheet. The image forming engines 30 are arranged around the intermediate transfer module 40, and a second transfer device 50 that transfers images, which have been transferred to the intermediate transfer module 40, onto the recording medium S is disposed on a portion of the intermediate transfer module 40. In addition, in a transport direction of the recording medium S, a fixing device 60 is disposed further downstream than a transfer region that is defined by the second transfer device 50, and the fixing device 60 fixes an unfixed image that has been transferred to the recording medium S onto the recording medium S. Note that, after the image has been fixed to the recording medium S, the recording medium S is ejected to an ejection tray (not illustrated).

### Intermediate Transfer Module

In the present exemplary embodiment, the intermediate transfer module 40 includes a belt-shaped intermediate transfer body 45 that is made of, for example, a polyimide resin (and that corresponds to the transfer medium 1 in FIG. 1A), and the intermediate transfer body 45 is stretched by a plurality (four in the present exemplary embodiment) of stretching rollers 41 to 44. For example, the intermediate transfer body 45 is capable of moving along a circular path in the direction of arrow A as a result of the stretching roller 41 being driven so as to rotate as a driving roller, and the tension that is exerted on the intermediate transfer body 45 is adjustable by using the stretching roller 44 as a tension roller.

In the exemplary embodiment, the intermediate transfer body 45 includes a horizontal movable portion 45a that extends between the stretching rollers 41 and 42 in a substantially horizontal direction and an inclined movable portion 45b that extends between the stretching rollers 41 and 43 in a substantially oblique direction.

In addition, an intermediate-transfer-body cleaning device 47 is disposed on a portion of the intermediate transfer body 45 that faces the stretching roller 42 so as to remove residues on the intermediate transfer body 45.

### Image Forming Engines

In the present exemplary embodiment, the image forming engines 30 each employs an electrophotographic system. More specifically, each of the image forming engines 30 includes a drum-shaped photoconductor 33 (that corresponds to one of the image holding units 4) and the following devices that are arranged around the photoconductor 33: a charging device (e.g., a charging roller) 34 that charges the photoconductor 33, a latent-image writing device (e.g., an LED writing head) 35 that writes an electrostatic latent image onto the charged photoconductor 33, a developing device 36 that develops the electrostatic latent image written on the photoconductor 33 with an image forming agent (a toner in the present exemplary embodiment), a transfer device 37 that is disposed so as to face the photoconductor 33 with the intermediate transfer body 45 interposed therebetween and that transfers, in a first transfer process, an image formed on the photoconductor 33 onto the intermediate transfer module 40 (a transfer roller is used as the transfer device 37 in the present exemplary embodiment, and the transfer device 37 corresponds to one of the transfer units 5 illustrated in FIG. 1A), and a cleaning device 38 that removes residues on the photoconductor 33 after the first transfer process.

Note that a corona discharge type device (such as a corotron or a scorotron) may be used as each of the charging devices 34, and an ion-current writing head may be used as each of the latent-image writing devices 35. Alternatively, each of the image forming engines 30 may include a laser exposure device, or a laser exposure device may be used by the image forming engines 30 in a shared manner.

### Second Transfer Device

In the present exemplary embodiment, the second transfer device 50 includes a second transfer roller 51 that is disposed on a portion of the intermediate transfer body 45 that faces the stretching roller 44 and transports the recording medium S by nipping the recording medium S between the second transfer roller 51 and the intermediate transfer body 45. In the second transfer device 50, a predetermined second transfer electric field is generated between the second transfer roller 51 and the stretching roller 44, which faces the second transfer roller 51, and an image held on the intermediate transfer body 45 is transferred onto the recording medium S. Note that, it is obvious that a second transfer belt that is stretched by a plurality of rollers may be used instead of the second transfer roller 51.

### Fixing Device

In the present exemplary embodiment, the fixing device 60 includes a heating and fixing member 61 whose surface is heated by a heating source (not illustrated) and a pressing and fixing member 62 that is pressurized while facing the heating and fixing member 61 and that transports the recording medium S by nipping the recording medium S between the heating and fixing member 61 and the pressing and fixing member 62.

Here, as the heating and fixing member 61 and the pressing and fixing member 62, roll-shaped members or belt-shaped members may be suitably selected. In addition, the heating source is not limited to a heater, and a heating source such as a heating source that employs an induction heating system may be suitably selected and used as the heating source. The heating source may be used for the pressing and fixing member 62.

### Classification of Image Forming Engines

In the present exemplary embodiment, the image forming engines 30 are divided into two upper image forming engines 31 (specifically, upper image forming engines 31a and 31b that correspond to upper image forming units 2 in FIG. 1A) each of which includes the transfer device 37 and the photoconductor 33 that is disposed above the transfer device 37 so as to face the transfer device 37 with the horizontal movable portion 45a of the intermediate transfer body 45 interposed therebetween and two lower image forming engines 32 (specifically, upper image forming engines 32a and 32b that correspond to lower image forming units 3 in FIG. 1A) each of which includes the transfer device 37 and the photoconductor 33 that is disposed below the transfer device 37 so as to face the transfer device 37 with the inclined movable portion 45b of the intermediate transfer body 45 interposed therebetween.

The transfer devices 37 used in the upper image forming engines 31 and the lower image forming engines 32 will be described below.

### Transfer Devices of Upper Image Forming Engines

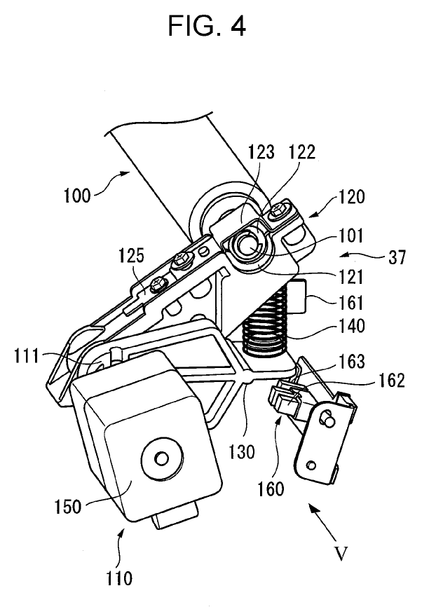

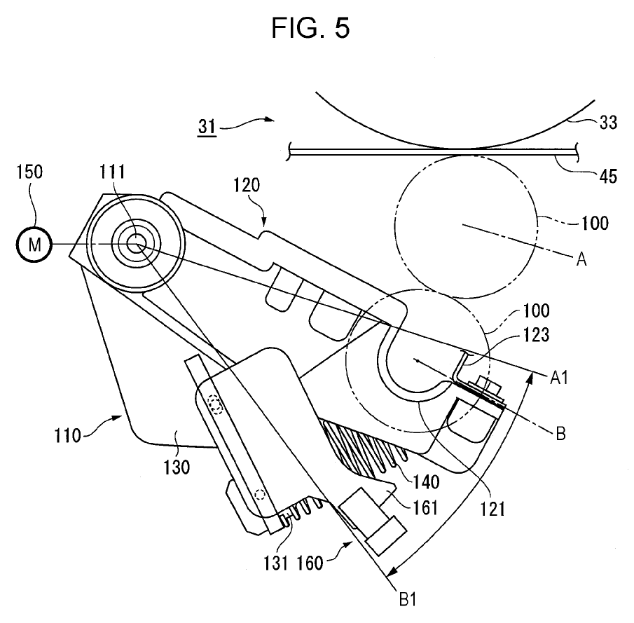

In the present exemplary embodiment, as illustrated in FIG. 4 and FIG. 5, the transfer devices 37 used in the upper image forming engines 31 each includes a transfer roller 100 (corresponding to the transfer member 6 in FIG. 1B) that extends in a direction crossing the direction in which the belt-shaped intermediate transfer body 45 moves and that rotates along with the intermediate transfer body 45 while being in contact with the rear surface of the intermediate transfer body 45 and pressing mechanisms 110 each of which holds and presses one of two end shaft portions 101 of the transfer roller 100 such that the two end shaft portions 101 of the transfer roller 100 are rotatable.

### Transfer Rollers

In the present exemplary embodiment, a first transfer voltage having a polarity opposite to that of a toner is applied to the transfer rollers 100, and a first transfer electric field is formed between the transfer rollers 100 and their respective photoconductors 33, so that toner images on the photoconductors 33 are transferred onto the intermediate transfer body 45 in the first transfer process.

Each of the transfer rollers 100 includes, for example, a hollow pipe made of a metal such as aluminum, SUS, or SUM and an elastic rubber member disposed around the hollow pipe.

### Pressing Mechanisms

In the present exemplary embodiment, the pressing mechanisms 110 independently operate for each of the upper image forming engines 31 (31a, 31b) and independently hold the two end shaft portions 101 of the transfer rollers 100.

Here, regarding the basic configuration of each of the pressing mechanisms 110, each of the pressing mechanisms 110 presses one of the transfer rollers 100 against the corresponding photoconductor 33 at a pressing position A with a predetermined transfer load when the transfer roller 100 is used, and each of the pressing mechanisms 110 causes the corresponding transfer roller 100 to move to a standby position B when, for example, the corresponding transfer device 37 is replaced.

More specifically, each of the pressing mechanisms 110 includes a transfer holding bracket 120 that serves as a transfer holding member and that is swingable about a rotary shaft 111 serving as a fulcrum, the transfer holding bracket 120 holding one of the shaft portions 101 of the corresponding transfer roller 100 at a position spaced apart from the rotary shaft 111, a pressing and holding arm 130 that serves as a pressing and holding member and that is fixed to the rotary shaft 111, which serves as a fulcrum, so as to be swingable along with rotation of the rotary shaft 111, a pressing spring 140 that is held between the transfer holding bracket 120 and the pressing and holding arm 130 so as to be capable of being elastically deformed, and a pressing motor 150 that rotates the rotary shaft 111 within a predetermined angle range so as to swing and rotate the pressing and holding arm 130 such that the pressing and holding arm 130 moves to the pressing position A where the transfer roller 100 is pressed against the corresponding photoconductor 33 and the standby position B where the transfer roller 100 is spaced apart from the rear surface of the intermediate transfer body 45.

The transfer holding bracket 120 includes a substantially U-shaped receiving portion 121 formed at a freely rotational end thereof that is spaced apart from the rotary shaft 111, the receiving portion 121 holding one of the two end shaft portions 101 of the corresponding transfer roller 100, and the one of the two end shaft portions 101 of the transfer roller 100 is rotatably held by a bearing 122 that is fixed to the receiving portion 121.

The receiving portion 121 of the transfer holding bracket 120 is provided with a holding-down portion 123 that holds down the bearing 122. Note that, in FIG. 4, reference sign 125 denotes a current-carrying electrode for energizing the transfer roller 100.

The pressing and holding arm 130 swings along with the rotational operation of the pressing motor 150 within the predetermined angle range and moves between a first position A1 that corresponds to the pressing position A of the transfer roller 100 and a second position B1 that corresponds to the standby position B of the transfer roller 100. Note that the first position A1 and the second position B1 are adjustable by suitably changing the rotation angle range of the pressing motor 150.

The pressing spring 140 is formed of a coil spring that is capable of being compressed and deformed. One end portion of the pressing spring 140 is held by a spring holding portion 131 of the pressing and holding arm 130 that is formed at a freely rotational end of the pressing and holding arm 130, and the other end portion of the pressing spring 140 is held by a spring holding portion (not illustrated) of the transfer holding bracket 120 that is formed at a position facing the spring holding portion 131. Accordingly, the pressing spring 140 is interposed and nipped between the pressing and holding arm 130 and the transfer holding bracket 120. When the pressing and holding arm 130 rotates in a direction toward the transfer holding bracket 120 so as to move from the second position B1 toward the first position A1, compression deformation occurs in the pressing spring 140, and then, the transfer holding bracket 120 is moved by the elastic restoring force of the pressing spring 140 in a direction away from the pressing and holding arm 130. Contrary to this, when the pressing and holding arm 130 rotates in a direction away from the transfer holding bracket 120 so as to move from the first position A1 toward the second position B1, tensile deformation occurs in the pressing spring 140, and then, the transfer holding bracket 120 is moved by the elastic restoring force of the pressing spring 140 in a direction toward the pressing and holding arm 130.

In addition, in the present exemplary embodiment, position detectors 160 are provided, and each of the position detectors 160 detects a corresponding one of the transfer rollers 100 being located at the standby position B. In the present exemplary embodiment, each of the position detectors 160 includes a shield plate 161 that is provided on the freely rotational end of the corresponding pressing and holding arm 130, a light-emitting unit 162, and a light-receiving unit 163, and when the pressing and holding arm 130 is located at the second position B1 (when the corresponding transfer roller 100 is located at the standby position B), the light-emitting unit 162 and the light-receiving unit 163 face each other with the shield plate 161, which is provided on the pressing and holding arm 130, interposed therebetween. Thus, in the present exemplary embodiment, each of the position detectors 160 is shielded from light by the shield plate 161 provided on the corresponding pressing and holding arm 130 that moves so as to follow the corresponding transfer roller 100 when the transfer roller 100 is located at the standby position B, so that the position detector 160 detects the transfer roller 100 being located at the standby position B.

Note that, regarding the pressing mechanisms 110 provided at the first and second end portions of each of the transfer rollers 100, the pressing mechanism 110 provided at the second end portion of the transfer rollers 100 may be disposed so as to be mirror symmetric to the pressing mechanism 100 at the first end portion of the transfer roller 100.

### Transfer Devices of Lower Image Forming Engines

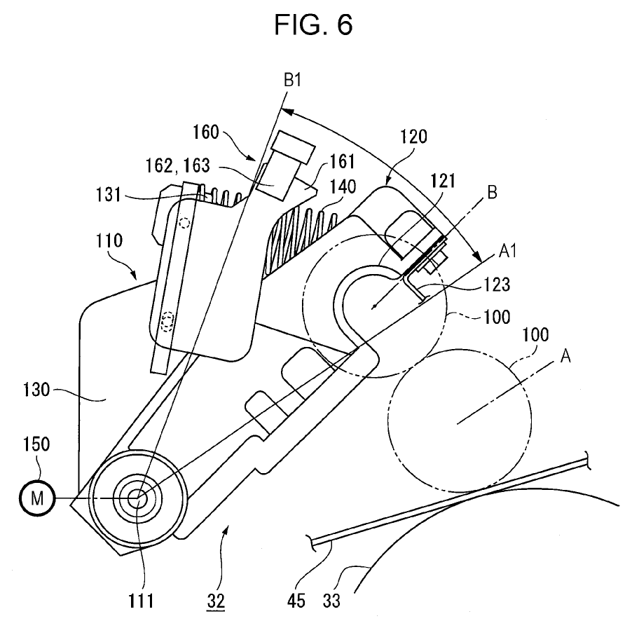

As illustrated in FIG. 6, the basic configuration of each of the transfer devices 37 that are used in the lower image forming engines 32 is substantially similar to that of each of the transfer devices 37 that are used in the upper image forming engines 31. In each of the lower image forming engines 32, the transfer device 37 includes the transfer roller 100 and the pressing mechanisms 110 (each of which includes the rotary shaft 111, the transfer holding bracket 120, the pressing and holding arm 130, the pressing spring 140, and the pressing motor 150). Although the fundamental parts of the transfer device 37 in each of the lower image forming engines 32 are the same as those of the transfer device 37 in each of the upper image forming engines 31, the arrangement of these parts in each of the lower image forming engines 32 is different from that in each of the upper image forming engines 31 and is obtained by turning the arrangement of the parts in each of the upper image forming engines 31 upside down. -Difference Between Configuration of Transfer Devices in Upper Image Forming Engines and Configuration of Transfer Devices in Lower Image Forming Engines-

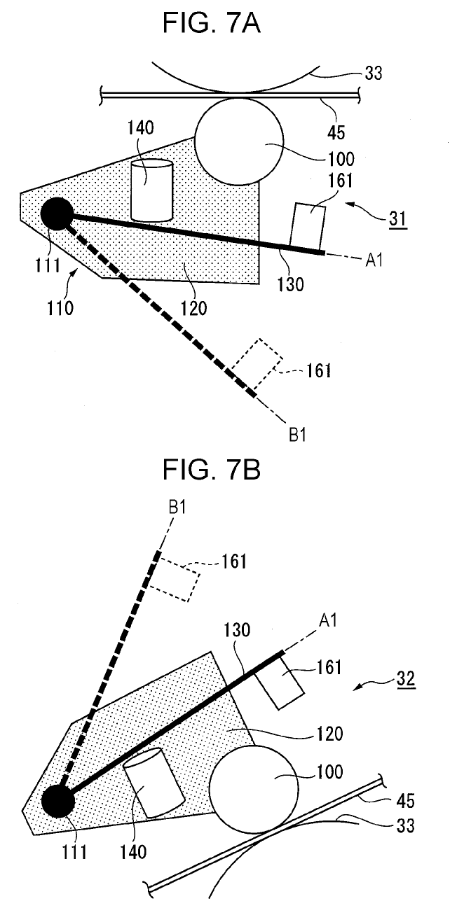

As described above, although the basic configuration of each of the transfer devices 37 of the upper image forming engines 31 and the basic configuration of each of the transfer devices 37 of the lower image forming engines 32 are substantially similar to each other as illustrated in FIGS. 7A and 7B, a configuration is employed in which a spring constant for each of the upper image forming engines 31 is set to be larger than that for each of the lower image forming engines 32 in order to adjust the elastic restoring forces of the pressing springs 140.

In other words, when the pressing springs 140 for the upper image forming engines 31 each have a spring constant k1 and the pressing springs 140 for the lower image forming engines 32 each have a spring constant k2, each of the pressing springs 140 may be selected in such a manner that the relationship of k1>k2 is satisfied.

### Setting Operation for Transfer Devices of Upper Image Forming Engines and Transfer Devices of Lower Image Forming Engines

In the present exemplary embodiment, in each of the upper image forming engines 31 and each of the lower image forming engines 32, when the transfer roller 100 of the transfer device 37 is set to the pressing position A, as illustrated in FIGS. 7A and 7B, the pressing and holding arm 130 of each of the pressing mechanisms 110 may be rotated by the pressing motor 150 so as to move from the second position B1 to the first position A1.

In the present exemplary embodiment, when it is assumed that the amount of elastic deformation of each of the pressing springs 140 becomes x0 as the pressing and holding arms 130 of the pressing mechanisms 110 move from the second position B1 to the first position A1, the pressing force P1 applied by each of the pressing mechanisms 110 of the upper image forming engines 31 is k1×x0, and the pressing force P2 applied by each of the pressing mechanisms 110 of the lower image forming engines 32 k2×x0.

Here, the relationship of k1>k2 is satisfied, the relationship of P1>P2 may be satisfied.

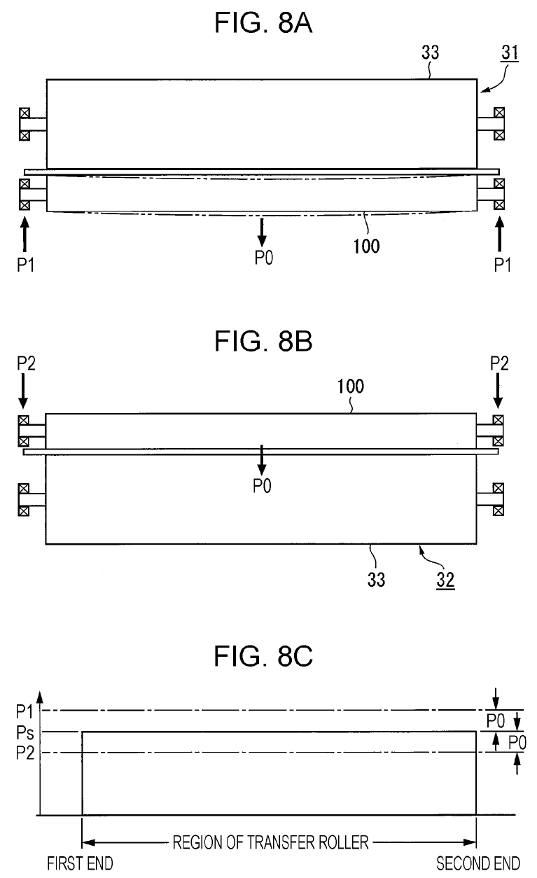

As described above, in each of the upper image forming engines 31 of the present exemplary embodiment, although the weight P0 of the transfer roller 100 acts in a direction opposite to the direction in which the pressing force P1 of each of the pressing mechanisms 110 acts as illustrated in FIGS. 8A and 8B, by increasing the pressing force P1 of each of the pressing mechanisms 110, a target load Ps of the pressing load of the transfer roller 100 is applied as P1 -P0 as illustrated in FIG. 8C.

In addition, in each of the lower image forming engines 32, the weight P0 of the transfer roller 100 acts in the same direction as the pressing force P1 of each of the pressing mechanisms 110, and thus, even if the pressing force P2 of each of the pressing mechanisms 110 is smaller than the target load Ps, the target load Ps of the pressing load of the transfer roller 100 is applied as P2 + P0 as illustrated in FIG. 8C.

Note that, when, for example, one of the transfer devices 37 is replaced, the pressing and holding arm 130 of each of the corresponding pressing mechanisms 110 may be rotated by the corresponding pressing motor 150 so as to move from the second position B1 to the first position A1, and the transfer roller 100 may be moved to the standby position B.

### Second Exemplary Embodiment

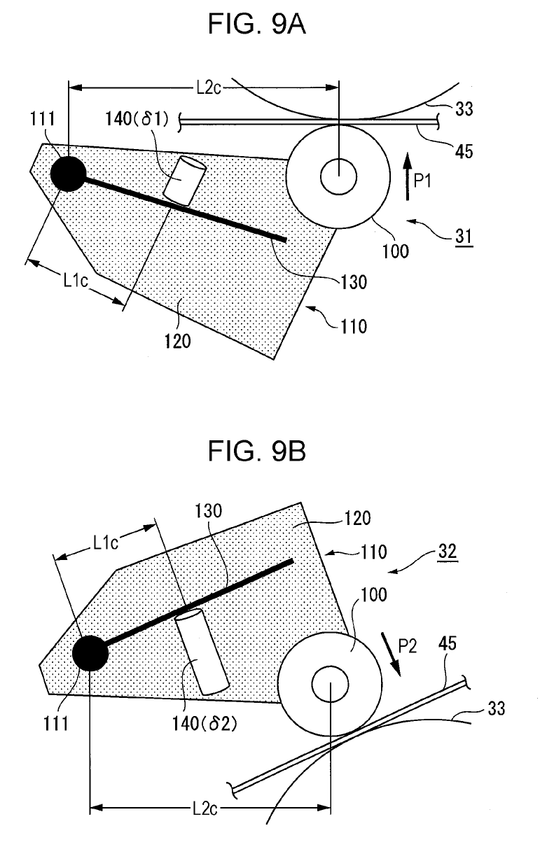

FIGS. 9A and 9B are diagrams each illustrating a principal portion of a transfer device included in an image forming apparatus according to the second exemplary embodiment.

In FIGS. 9A and 9B, although the basic configuration of each of the transfer devices 37 of the upper image forming engines 31 and the basic configuration of each of the transfer devices 37 of the lower image forming engines 32 are substantially similar to those in the first exemplary embodiment, in order to adjust the elastic restoring forces of the pressing springs 140, for example, the pressing springs 140 having the same spring constant are used, and the amount of elastic deformation (the amount of compression in the present exemplary embodiment) of each of these pressing springs 140 is adjusted instead of employing the method of adjusting a spring constant, the method being employed in the first exemplary embodiment.

In each of the pressing mechanisms 110 of the present exemplary embodiment, when the distance on the pressing and holding arm 130 from the rotary shaft 111, which serves as a fulcrum, to the position where the pressing spring 140 is held is denoted by L1c and the distance on the transfer holding bracket 120 from the rotary shaft 111, which serves as a fulcrum, to the position where the transfer roller 100 is held is denoted by L2c, the amount of elastic deformation (compression amount) δ of each of the pressing springs 140 having the same spring constant may be set so as to satisfy the relationship of δ1>δ2, where δ1 stands for the amount of elastic deformation (compression amount) of each of the pressing springs 140 included in the upper image forming engines 31 and δ2 stands for the amount of elastic deformation (compression amount) of each of the pressing springs 140 included in the lower image forming engines 32.

In this case, in order to increase the amount of elastic deformation (compression amount) δ1 of each of the pressing springs 140 of the upper image forming engines 31 to be larger than the amount of elastic deformation (compression amount) δ2 of each of the pressing springs 140 of the lower image forming engines 32, the moving angle of the pressing and holding arm 130 of each of the upper image forming engines 31 from the second position B1 to the first position A1 may be set to be larger than that of the pressing and holding arm 130 of each of the lower image forming engines 32.

As a result, the pressing force P1 of each of the pressing mechanisms 110 of the upper image forming engines 31 and the pressing force P2 of each of the pressing mechanisms 110 of the lower image forming engines 32 may have a magnitude relationship of P1>P2.

In this manner, in the upper image forming engines 31 and the lower image forming engines 32, the magnitude of each of the pressing forces P1 and P2 may be suitably adjusted by taking into consideration the weight P0 of each of the transfer roller 100.

### Third Exemplary Embodiment

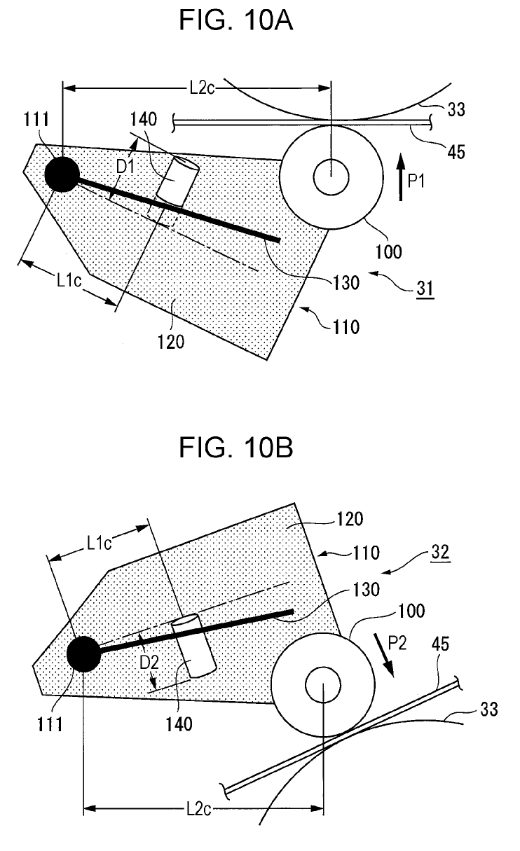

FIGS. 10A and 10B are diagrams each illustrating a principal portion of a transfer device of an image forming apparatus according to the third exemplary embodiment.

In FIGS. 10A and 10B, although the basic configuration of the transfer device 37 of each of the upper image forming engines 31 and the basic configuration of the transfer device 37 of each of the lower image forming engines 32 are substantially similar to those in the second exemplary embodiment, unlike the second exemplary embodiment, for example, when the distance between the position at which the pressing spring 140 is held by the transfer holding bracket 120 and the position at which the pressing spring 140 is held by the pressing and holding arm 130 is denoted by D, the value of D for each of the upper image forming engines 31 is set to be larger than the value of D for each of the lower image forming engines 32. Note that, in FIGS. 10A and 10B, a position of the pressing and holding arm 130 that is indicated by the solid line corresponds to the first position A1, and a position of the pressing and holding arm 130 that is indicated by a one-dot chain line corresponds to a position where an end of the pressing spring 140 is held when the pressing spring 140 has its equilibrium length.

In other words, as illustrated in FIG. 10A, when the distance between the positions at each of which the pressing spring 140 is held in each of the upper image forming engines 31 is denoted by D1 and the distance between the positions at each of which the pressing spring 140 is held in each of the lower image forming engines 32 is denoted by D2, these distances may be set such that the relationship of D1>D2 is satisfied, so that, when each of the pressing and holding arms 130 is moved to the first position A1 so as to set the corresponding transfer roller 100 to the pressing position A, the pressing spring 140 with which the distance D between the positions at which the pressing spring 140 is held when the pressing spring 140 has its equilibrium length is larger (D = D1) may secure a larger amount of compression than that secured by the pressing spring 140 with which the distance D is smaller (D = D2).

Thus, also in the present exemplary embodiment, the pressing force P1 of each of the pressing mechanisms 110 of the upper image forming engines 31 and the pressing force P2 of each of the pressing mechanisms 110 of the lower image forming engines 32 may have the magnitude relationship of P1>P2.

### Fourth Exemplary Embodiment

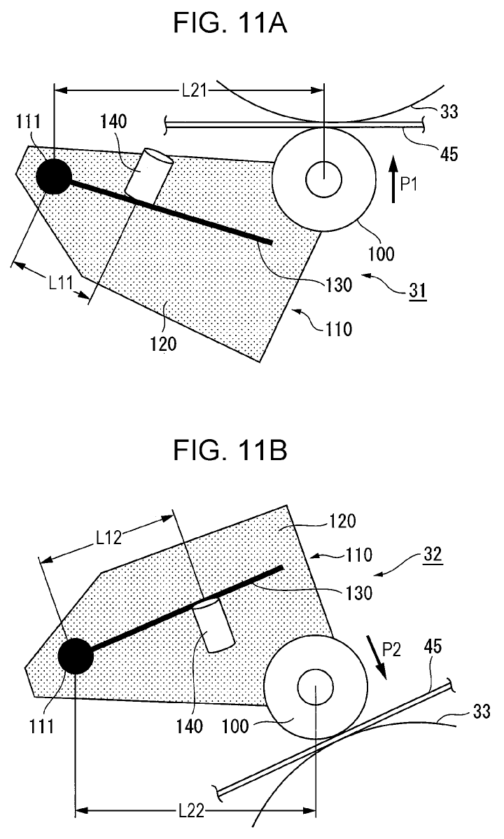

FIGS. 11A and 11B are diagrams each illustrating a principal portion of a transfer device of an image forming apparatus according to the fourth exemplary embodiment.

In the present exemplary embodiment, the pressing forces P1 and P2 applied to the transfer rollers 100 are adjusted by changing the arrangement of the pressing mechanisms 110 of the upper image forming engines 31 and the arrangement of the pressing mechanisms 110 of the lower image forming engines 32.

In the present exemplary embodiment, as illustrated in FIGS. 11A and 11B, in each of the pressing mechanisms 110 of the upper image forming engines 31 and the lower image forming engines 32, when the distance on the pressing and holding arm 130 from the rotary shaft 111, which serves as a fulcrum, to the position where the pressing spring 140 is held is denoted by L1 (specifically, L11, L12) and a distance on the transfer holding bracket 120 from the rotary shaft 111, which serves as a fulcrum, to the position where the transfer roller 100 is held is denoted by L2 (specifically, L21, L22), the value of L2/L1 for each of the upper image forming engines 31 is set to be larger than the value of L2/L1 for each of the lower image forming engines 32.

According to the present exemplary embodiment, the distance L11 in each of the upper image forming engines 31 is shorter than the distance L12 in each of the lower image forming engines 32, and thus, it is understood that the ratio of L2/L1 in each of the upper image forming engines 31 is larger than that in each of the lower image forming engines 32 even if L21 ≈ L22.

In this case, the pressing forces P1 and P2 of the pressing springs 140 are each obtained by multiplying the elastic restoring force of the corresponding pressing spring 140 associated with the amount of compression of the pressing spring 140 by the ratio of L2/L1.

Thus, also in the present exemplary embodiment, the pressing force P1 of each of the pressing mechanisms 110 of the upper image forming engines 31 and the pressing force P2 of each of the pressing mechanisms 110 of the lower image forming engines 32 may have the magnitude relationship of P1>P2.

### Fifth Exemplary Embodiment

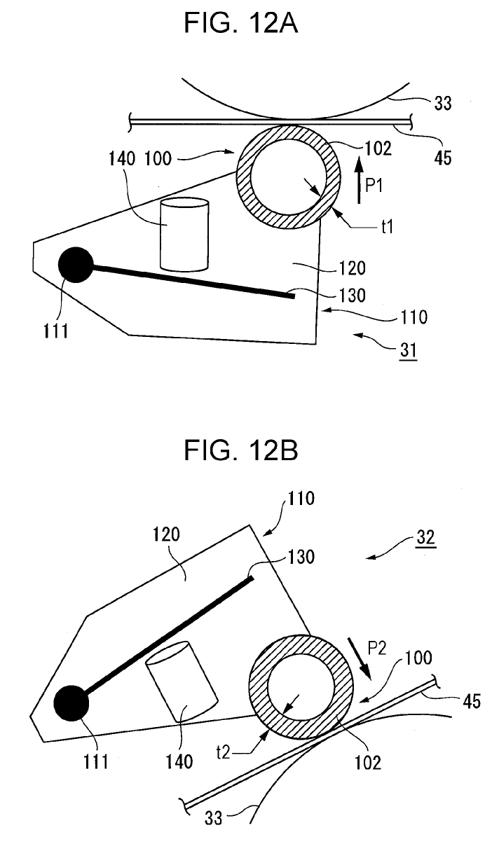

FIGS. 12A and 12B are diagrams each illustrating a principal portion of a transfer device of an image forming apparatus according to the fifth exemplary embodiment.

The present exemplary embodiment is intended to improve an image quality defect by setting the configuration of the transfer roller 100 included in each of the upper image forming engines 31 and the configuration of the transfer roller 100 included in each of the lower image forming engines 32 to be different from each other.

In FIGS. 12A and 12B, although the transfer devices 37 of the upper image forming engines 31 and the transfer devices 37 of the lower image forming engines 32 use essentially the same pressing mechanisms 110, unlike the first to fourth exemplary embodiments, the transfer rollers 100 have different configurations.

In the present exemplary embodiment, hollow pipes 102 are used as the transfer rollers 100 of the upper image forming engines 31 and the transfer rollers 100 of the lower image forming engines 32, and when a thickness t of each of the hollow pipes 102 of the upper image forming engines 31 is denoted by t1 and a thickness t of each of the hollow pipes 102 of the lower image forming engines 32 is denoted by t2, the relationship of t1<t2 is satisfied. In this case, when these hollow pipes 102 are made of the same material, each of the hollow pipes 102 of the upper image forming engines 31 is lighter in weight than each of the hollow pipes 102 of the lower image forming engines 32.

Thus, as illustrated in FIG. 12A, in each of the upper image forming engines 31, the weight P0 of the transfer roller 100 is reduced, and accordingly, the amount of deflection of a center portion of the transfer roller 100 in the longitudinal direction due to the weight P0 is reduced. In addition, there is little concern that the pressing force P1 applied to the transfer roller 100 by the corresponding pressing mechanism 110 will be excessively reduced by the weight P0 of the transfer roller 100.

### Sixth Exemplary Embodiment

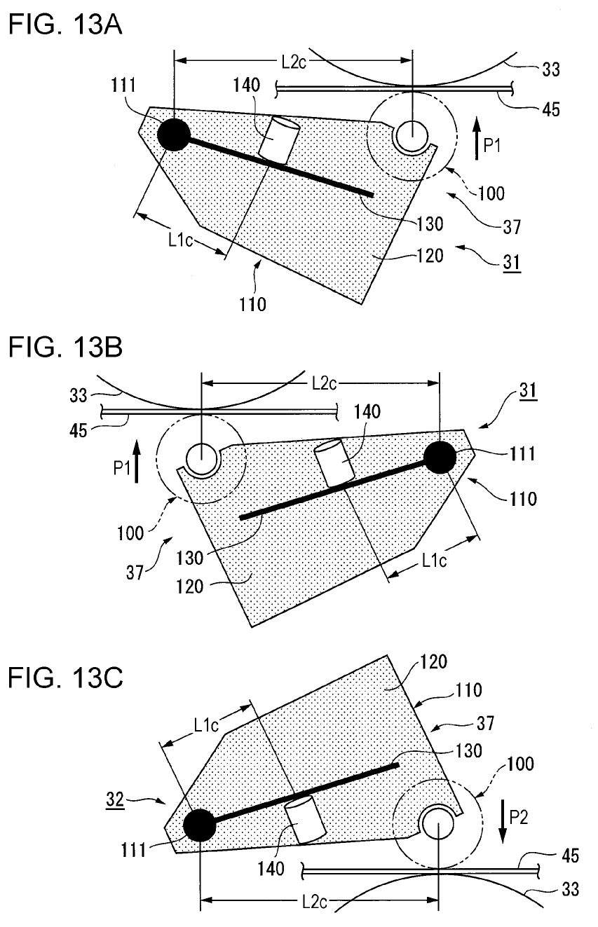

FIGS. 13A to 13C are diagrams each illustrating a principal portion of a transfer device of an image forming apparatus according to the sixth exemplary embodiment.

In FIGS. 13A to 13C, when the pressing mechanisms 110 of the upper image forming engines 31 and the pressing mechanisms 110 of the lower image forming engines 32 are incorporated, for example, it goes without saying that the pressing mechanisms 110 holding the two end portions of the transfer roller 100 in each of the upper image forming engines 31 and the pressing mechanisms 110 holding the two end portions of the transfer roller 100 in each of the lower image forming engines 32 are independently configured on the left-hand and right-hand sides or on the upper and lower sides.

However, in the present exemplary embodiment, FIG. 13A illustrates one of the pressing mechanisms 110 that holds and presses the first end portion of the transfer roller 100 in the transfer device 37 of one of the upper image forming engines 31.

FIG. 13B illustrates one of the pressing mechanisms 110 that holds and presses the second end portion of the transfer roller 100 in the transfer device 37 of the upper image forming engine 31. In the present exemplary embodiment, all or some of the components (e.g., the transfer holding bracket 120, the pressing and holding arm 130, the pressing spring 140) forming each of the pressing mechanisms 110 are used as shareable components, and the pressing mechanism 110 at the second end portion is disposed so as to be mirror symmetric to the pressing mechanism 100 at the first end portion.

In addition, FIG. 13C illustrates one of the pressing mechanisms 110 that holds and presses the first end portion of the transfer roller 100 in the transfer device 37 of one of the lower image forming engines 32. In the present exemplary embodiment, all or some of the components (e.g., the transfer holding bracket 120, the pressing and holding arm 130, the pressing spring 140) forming the pressing mechanism 110 used in each of the upper image forming engines 31 are used as shareable components, and the pressing mechanism 110 illustrated in FIG. 13C is disposed so as to be mirror symmetric to the pressing mechanism 110 that is provided at the first end portion of one of the upper image forming engines 31 and that is turned upside down.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
at least one upper image forming unit in which an image holding unit is disposed above a transfer unit in such a manner as to face the transfer unit with a transfer medium, which moves in a predetermined direction, interposed between the image holding unit and the transfer unit; and
at least one lower image forming unit in which an image holding unit is disposed below a transfer unit in such a manner as to face the transfer unit with the transfer medium interposed between the image holding unit and the transfer unit,
wherein the transfer unit of the upper image forming unit and the transfer unit of the lower image forming unit each include a transfer member that extends in a width direction crossing the direction of movement of the transfer medium and that is brought into contact with the transfer medium and a pressing unit that presses the transfer member toward the image holding unit, and
wherein the pressing units are set in such a manner that a pressing force that is applied by one of the pressing units to the transfer member of the upper image forming unit is larger than a pressing force that is applied by another one of the pressing units to the transfer member of the lower image forming unit in a direction that makes pressing loads of the transfer members against the image holding units equal.

2. The image forming apparatus according to claim 1,
wherein the pressing units each include a pressing spring that presses the corresponding transfer member, and elastic restoring forces of the pressing springs are adjusted.

3. The image forming apparatus according to claim 2,
wherein a spring constant of the pressing spring for the upper image forming unit is larger than a spring constant of the pressing spring for the lower image forming unit.

4. The image forming apparatus according to claim 2,
wherein an amount of elastic deformation of the pressing spring for the upper image forming unit is larger than an amount of elastic deformation of the pressing spring for the lower image forming unit.

5. The image forming apparatus according to claim 1,
wherein each of the transfer members is held by a transfer holding member, which is swingable about a fulcrum, at a position spaced apart from the fulcrum, and
wherein each of the pressing units includes the transfer holding member, a pressing and holding member that is disposed so as to be swingable about the fulcrum with respect to the transfer holding member, and a pressing spring that is held between the transfer holding member and the pressing and holding member in such a manner as to be capable of being elastically deformed.

6. The image forming apparatus according to claim 5,
wherein, when a distance on each of the pressing and holding members from the fulcrum to the position at which the pressing spring is held is denoted by L1 and a distance on each of the transfer holding members from the fulcrum to the position at which the transfer member is held is denoted by L2, a value of L2/L1 for the upper image forming unit is larger than a value of L2/L1 for the lower image forming unit.

7. The image forming apparatus according to claim 5,
wherein, when a distance between a position at which the pressing spring is held by the transfer holding member and a position at which the pressing spring is held by the pressing and holding member in each of the upper and lower image forming units is denoted by D, a value of D for the upper image forming unit is larger than a value of D for the lower image forming unit.

8. The image forming apparatus according to claim 1,
wherein the pressing unit of the upper image forming unit and the pressing unit of the lower image forming unit operate independently of each other.

9. The image forming apparatus according to claim 8,
wherein the pressing units independently hold two end portions of the respective transfer members in a longitudinal direction of the transfer members.

10. The image forming apparatus according to claim 1,
wherein all or some of components that are used in at least one of a plurality of the upper image forming units and at least one of a plurality of the lower image forming units are sharable by the pressing units.

11. The image forming apparatus according to claim 10,
wherein all or some of components that are used in at least one of the upper image forming units or the lower image forming units are sharable by the pressing units at two end portions of the respective transfer members in a longitudinal direction of the transfer members.

12. The image forming apparatus according to claim 1,
wherein each of the transfer members is a transfer roller that includes a hollow pipe.

13. The image forming apparatus according to claim 2,
wherein each of the transfer members is a transfer roller that includes a hollow pipe.

14. The image forming apparatus according to claim 3,
wherein each of the transfer members is a transfer roller that includes a hollow pipe.

15. The image forming apparatus according to claim 4,
wherein each of the transfer members is a transfer roller that includes a hollow pipe.

16. The image forming apparatus according to claim 5,
wherein each of the transfer members is a transfer roller that includes a hollow pipe.

17. The image forming apparatus according to claim 6,
wherein each of the transfer members is a transfer roller that includes a hollow pipe.

18. An image forming apparatus comprising:
an upper image forming unit in which an image holding unit is disposed above a transfer unit in such a manner as to face the transfer unit with a transfer medium, which moves in a predetermined direction, interposed between the image holding unit and the transfer unit; and
a lower image forming unit in which an image holding unit is disposed below a transfer unit in such a manner as to face the transfer unit with the transfer medium interposed between the image holding unit and the transfer unit,
wherein the transfer unit of the upper image forming unit and the transfer unit of the lower image forming unit each include a transfer member that extends in a width direction crossing the direction of movement of the transfer medium and that is brought into contact with the transfer medium and a pressing unit that presses the transfer member toward the image holding unit, and
wherein the transfer member of the upper image forming unit is lighter in weight than the transfer member of the upper image forming unit.

19. The image forming apparatus according to claim 18,
wherein each of the transfer members is a transfer roller that includes a hollow pipe, and a thickness of the hollow pipe for the upper image forming unit is smaller a thickness of the hollow pipe for the lower image forming unit.

20. The image forming apparatus according to claim 18,
wherein the pressing units are set in such a manner that a pressing force that is applied by one of the pressing units to the transfer member of the upper image forming unit is larger than a pressing force that is applied by another one of the pressing units to the transfer member of the lower image forming unit in a direction that makes pressing loads of the transfer members against the image holding units equal.
